(19) United States
(12) Patent Application Publication
(10) Pub. No.: US 2003/0176271 A1
(43) Pub. Date: Sep. 18, 2003

(54) Porous molded bodies from polycrystalline silicon nitride and method for producing the same

(76) Inventor: Jochen Kriegesmann, Hohr-Grenzhausen (DE)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/296,026

(22) PCT Filed: May 21, 2001
(86) PCT No.: PCT/EP01/05774

(30) Foreign Application Priority Data
May 20, 2000 (DE) DE-A-100 25 198.6

(51) Int. Cl. C04B 35/584

(52) U.S. Cl. 501/97.1; 501/80; 264/683

(57) ABSTRACT

The invention concerns a new and improved method for the production of porous and formed bodies with polycrystalline structure that meets the high quality requirements of the usually excellent material characteristics of porous and formed bodies based on silicon nitride and, at the same time, at least considerably reduces known disadvantages of other state-of-the-art techniques. In this, it is provided to first precompress the silicon nitride powder mix with a modal particle distribution of coarse and fine particles to form a green body, and to subsequently bake it using a temperature-based sintering process.

The invention concerns a method for the production of porous and formed bodies from polycrystalline silicon nitride and a porous and formed body in particular produced using this method.

Formed bodies made of ceramic material are usually formed at room temperature and, in most cases, gain their typical material characteristics through a sintering process carried out at high temperatures.

In this connection, non-oxidized ceramics, to which, in particular belong compounds of silicon with nitrogen or carbon, have a high percentage of covalent linkages basically giving them very good mechanical characteristics even in applications with high temperatures.

To be able to use this material to manufacture also bigger-sized formed bodies such as, for example, kiln furniture, burner nozzles, rollers for roller ovens, heating elements or ignition pins with high precision, an important criterion must be seen in the fact that there must be no or only very little shrinkage during consolidation.

There are several known methods for a mostly shrinkage-free production of formed bodies from certain ceramic materials, and, as a rule, a certain porosity develops depending on the production method and/or type of linkage.

For formed bodies based on silicon carbide, a silicon carbide powder existing in the form of bimodal particles is usually used as a starting material for the basically shrinkage-free production. Using a production process such as, for example, slip casting, a green body is produced. After the ejection of the green body, it goes through a sintering process for further curing during which the grain growth of the silicon carbide particles leads to the development of a relatively coarse structure (recrystallized silicon carbide —RSC).

With commercially used recrystallized silicon carbide, the coarse part of the bimodal particle spectrum usually ranges at about 100 μm. The temperatures required for the shrinkage-free consolidation of formed bodies based on silicon carbide used for the production of commercial products are around 2200° C. which is the highest baking temperature of all silicon carbide materials.

As far as the characteristics connected to ceramic materials are concerned, silicon nitride and thus also formed is bodies made of it show a hitherto unequalled combination of outstanding material characteristics. These characteristics in particular relate to an extremely high solidity, very low thermal expansion and also an excellent thermal fatigue resistance.

Thus, experts in this field often use silicon nitride for the production of formed bodies made of ceramic materials.

Already for years, the only method for the precise manufacturing of big-sized components or formed bodies containing silicon nitride is based on a chemical vapour reaction, respectively chemical gas reaction, where reaction-sintered or reaction-bonded silicon nitride (RBSN) is consolidated basically shrinkage-free.

The principle of this method is that elemental silicon as starting powder in the green body reacts chemically with atmospheric nitrogen during the baking process and forms silicon nitride (Si₃N₄); in this, the developing silicon nitride crystallites build up a solid grain-to-grain contact (reaction linkage).

A disadvantage of this method is, however, the fact that the starting materials for the development of the reaction-bonded silicon nitride must be optimised empirically in order to grant a sufficient quality, which means, for example, that also the atmosphere for the nitration of the silicon must be specially set up. Furthermore, the nitration of the silicon takes place at about 1200° C. to 1450° C., but silicon itself has a melting point of ca. 1410° C., which means that reaction-bonded silicon nitride, because of the resulting particle sizes of maximum 2 μm, has a relatively high susceptibility to oxidation.

To compound matters further, the reaction times for a full nitration of reaction-bonded silicon nitride are usually very long and take, as experience shows, up to one week.

One object of the invention is thus to provide a new and improved method (if compared to state-of-the-art methods) for the production of porous and formed bodies with polycrystalline structure that meets the high quality requirements imposed by the excellent material characteristics experienced with formed bodies based on silicon nitride and, at the same time, reduces the aforesaid disadvantages of the currently used technique.

In a very surprising way, the invention's object has already been fulfilled through a method with the features of claim 1.

Advantageous and/or suitable embodiments or further developments of the invention-based method are subject to the dependent claims.

With regard to the invention, it is intended to use a mix of a silicon nitride powder with modal particle distribution for the production of porous and formed bodies under exclusion of sintering additives, in which the powder is first precompressed for the formation of green bodies and then baked to produce formed bodies using a temperature-based sintering process.

In this connection one advantage is that a sintering mechanism leading to shrinkage is suppressed because of the modal particle distribution in the silicon nitride powder. Furthermore, it is possible to set up different textures and to bring about certain characteristics that will later on be required from the formed body depending on its application or field of application already through the chosen particle distribution.

Besides this, the invention-based method reduces the production time in particular if compared to the that of porous and formed bodies based on reaction-bonded silicon nitride. Compared to porous and formed bodies based on silicon carbide, the invention-based method requires a considerably lower sintering temperature. The porous and formed bodies produced according to the invention-based method additionally distinguish themselves from the corresponding porous silicon carbide materials by an improved thermal fatigue resistance, a lower caloric conductibility and a lower co-efficient of thermal expansion.

For an optimisation of the invention-based production method, a bimodal particle distribution of coarse and fine particles has proved to be appropriate, in particular with regard to the possibility to set up cage-building structural areas and structural areas supporting particle-to-particle-linkage.

A further, considerable improvement to the material characteristics especially with respect to solidity and oxidation stability can be made with coarse particles, that is, in particular cage-building supporting particles with particle sizes between 5 μm and 150 μm, which proved to be worthwhile in practice for the performance of the invention-based method.

Through the variation of the supporting particles, in particular, it is possible to produce formed body structures with special pore sizes in homogeneous distribution. This variation of the crystalline structure leads to a variation spectrum that is in particular required for formed bodies that are used for filtration purposes. Such a variation is not possible with reaction-bonded silicon nitride.

It is even possible to produce graduated structures with cross-sectional variations that are also desired for membranes or filters. Thus it is possible to produce films with different structures applying a film-casting forming method as, for example, the so-called “Doctor Blade Process”. Using a laminating process these films with their different structures are already linked and interlocked in their green, i.e., not baked state. As the burning of these formed bodies happens without shrinkage, distortion does not occur so that monolithic ceramics with cross-sectionally varying structures and in particular pore sizes are preserved. Even structures with continuously changing cross sections can be produced, e.g., using a electrophoretic production process.

Furthermore, a mass proportional distribution of at least 50% of coarse particles and at least 30% of fine particles proved to be useful.

More especially, in order to considerably better support a sublimation precipitation mechanism taking place in the course of the invention-based process, it is additionally planned to use β silicon nitride crystals as these develop more spheroid particle forms than α silicon nitride crystals.

For the performance of the invention-based process, temperatures from 1550° C. up to 1800° C. proved to be suitable to produce formed bodies with an even structure and a homogeneous distribution.

The invention-based process is described in detail in the following with implementation examples.

As starting material for the implementation of the invention-based process, a mix of silicon nitride powders with different particle sizes is used. It could be determined that already a modal, and therefore a mainly non-continuous and/or also incomplete particle distribution, that arises after the mixing of the different particle shares, can suppress a shrinkage-causing sintering mechanism and ensures a solidification of the formed body during the consolidation process in which the development of a cage structure is supported by coarse particle grains and the finer particle grains provide for the linkage and cross-linkage of the cage structure.

It also turned out, however, that for the set-up of an even structure with a homogeneous distribution, a bimodal particle distribution of coarse and fine particles is useful in a practical way.

To develop a sufficient supporting structure mixtures with a percentage of coarse particles of at least 50% and of fine particles of at least 30%, of the overall weight of the respective mixtures were used. With a silicon nitride powder mixture with a percentage of fine particles of less than 30% of the overall weight, however, only an insufficient cross linkage could be achieved. If the percentage of coarse particles is less than 50%, shrinkage reactions may occur.

In addition, it turned out that through the use of silicon nitride powder in its β-form that develops at low partial oxygen pressure and high temperature, in particular for the provision of coarse particles, the consolidation process is considerably assisted because of the more spheroidal particle form compared to those of α-silicon nitride.

The supporting particles used for the construction of the cage had particle sizes between 5 μm and 150 μm. As far as the size of the finer particles is concerned, there is practically no lower limit and it may reach down to the submicron area, as the steam pressure over the fine particles that considerably supports the sublimation precipitation mechanism occurring during consolidation is higher the finer the particles are.

As forming method for the precompression of the silicon nitride powder mix, the slip casting technique was predominantly used. However, the forming may also be carried out with any other method known to the expert in this field as, for example, a pressing method, a injection moulding method, or a film casting method. After the ejection of the green bodies and their essentially full drying, they went through a temperature-based sintering process.

To achieve the desired qualities of each set-up structure a temperature range between 1550° C. and max. 1800° C. proved to be worthwhile. This temperature range furthermore avoids, on the one hand, that a disintegration of the silicon nitride into its elements takes place and, on the other hand, a β-α-transformation is excluded for the most part.

It was determined that using the invention-based method, the sintering process and thus the consolidation could be seen as completed after several hours already. With some set-up structures, the fine linking particles already disappeared after ca. 6 hours. The maximum shrinkage ranged below one percent compared to the green body.

It must be pointed out that the invention-based method, where no sintering additives are used and only the oxygen contained on the surface of the silicon nitride powder is tolerable, also allows the production of formed bodies with additionally embedded fibres.

For the further densification of the silicon-nitride-based porous and formed body in accordance with the invention-based method, the processes of infiltration or coating that are known to experts in this field would be a proper solution.

With applications at temperatures up to 1400° C., even at rising temperatures, no decrease in flectional resistance values of the individual recrystallised silicon structures of 80 to 200 megapascal were observed.

Especially in comparison to the ceramic materials on the basis of silicon carbide, the porous and formed body produced in accordance with the invention-based method stands out, amongst other things, due to its better thermal fatigue resistance, a lower caloric conductibility and a very low co-efficient of thermal expansion of ca. 3.2×10⁻⁶ per Kelvin. Furthermore, a formed body produced in accordance with the invention-based method distinguishes itself from reaction-bonded silicon nitride through a considerably enhanced oxidation resistance.

Because of this combination of excellent material characteristics the porous and formed bodies produced basically shrinkage-free using the invention-based method, they are particularly suitable for a usage as kiln furniture, burner nozzles, rollers for roller ovens, and as filters in the area of hot gas filtration and/or dust extraction, but also as material for grinding wheels, including for metal carbide processing.

Besides this, even at rising temperature, the non-conductor characteristics are considerably improved compared to technical materials based on silicon carbide, so that formed bodies made of recrystallised silicon nitride are also perfectly suitable for applications as base plates and/or carrier boards, e.g., for electrical circuits.

1. Method for the production of porous and formed bodies from polycrystalline silicon nitride characterised by the following process steps:
provision of a silicon nitride powder with modal particle distribution of coarse and fine particles;
precompression of the silicon nitride powder to form green bodies; and
high-temperature sintering of the precompressed green body.

2. Method according to claim 1, characterised by the use of a basically bimodal particle distribution.

3. Method according to one of the claim 1 or 2, characterised by the use of a particle size between 5 μm and 150 μm for coarse particles.

4. Method according to any of the claims 1 through 3, characterised in that the texture of the formed body can be defined depending on the distribution and/or size of the particles.

5. Method according to any of the claims 1 through 4, characterised by the use of a mass percent distribution of at least 50% of coarse particles and at least 30% of fine particles for the particle distribution.

6. Method according to any of the claims 1 through 5, characterised by the use of β-silicon nitride crystals for the production of the formed body.

7. Method according to any of the claims 1 through 6, characterised in that sintering is carried out at a temperature in the range from 1550° C. up to a maximum of 1800° C.

8. A porous and formed body from polycrystalline silicon nitride, especially produced using a method according to any of the claims 1 through 7, characterised by a texture with a particle size of at least 5μm.

9. A porous and formed body from polycrystalline silicon nitride, according to claim 8, characterised by a texture with a varying cross-section.

10. A porous and formed body from polycrystalline silicon nitride according to claim 8 or 9, characterised by a co-efficient of thermal expansion of ca. 3.2×10⁻⁶ per Kelvin.
